(19) United States
(12) Patent Application Publication
(10) Pub. No.: US 2025/0389385 A1
(43) Pub. Date: Dec. 25, 2025

(54) GIGAVAULT FACILITIES WITH TUBULAR COMPOSITE SEALED VESSELS FOR STORAGE OF MEDIA

(71) Applicant: BRAINDRIP, LLC, JACKSONVILLE, FL (US)

(72) Inventors: Kent Weisenberg, Jacksonville, FL (US); Cory James Kreutzer, Arvada, CO (US); Michael Cosgrove Peters, Centennial, CO (US)

(73) Assignee: BRAINDRIP, LLC, JACKSONVILLE, FL (US)

(21) Appl. No.: 19/243,351

(22) Filed: Jun. 19, 2025

Related U.S. Application Data
(60) Provisional application No. 63/662,529, filed on Jun. 21, 2024.

(51) Int. Cl. F17C 1/02; F17C 1/16

(52) U.S. Cl. CPC F17C 1/02; F17C 1/16; F17C 2201/0138; F17C 2201/032; F17C 2201/035; F17C 2203/012; F17C 2203/0624; F17C 2203/066; F17C 2203/0663; F17C 2205/0146; F17C 2205/0323; F17C 2209/2154; F17C 2221/012; F17C 2250/0421; F17C 2250/043; F17C 2250/0439; F17C 2250/0443; F17C 2260/038

(57) ABSTRACT

Disclosed herein is a “gigavault” facility for the storage of liquids and gases. The facility comprises a plurality of tubular composites which can provide continuous monitoring for safety and durability, and which can flexibly accommodate a variety of different media. Also disclosed are methods for the storage of media, including liquids and gases.

### CROSS REFERENCE TO RELATED APPLICATIONS

This application claims priority to U.S. Provisional Patent Application Ser. No. 63/662,529, filed on Jun. 21, 2024, and titled “Gigavault Facilities with Tubular Composite Sealed Vessels for Storage of Media,” the disclosure of which is incorporated herein by reference.

### FIELD

Disclosed herein are facilities and related methods for the storage of liquids and gases.

### BACKGROUND

The use of sealed vessels is widespread in industry for storage and transmission of various media, including liquids and gases. Vessels must satisfy several requirements. Most importantly, they must contain the media without significant leakage, for both commercial and safety reasons. The vessel must have sufficient strength to withstand the forces applied from both the outside and from within, particularly for storing pressurized gases. The vessel must meet a specific design lifetime at the rated operating conditions. Containment of hazardous media requires that the vessel be designed of materials that are compatible with the media and not subject to degradation in the form of corrosion, embrittlement, or other mechanisms. For hazardous media storage, the health of the vessel should be monitored as well.

Many types of tubular composites are available for handling liquid and/or gaseous media. Composite overwrapped pressure vessels have widespread use in a range of industry applications and offer many advantages over traditional vessels, including reduced weight, better corrosion resistance, and elimination of unique chemical interactions such as hydrogen embrittlement. The base material's primary purpose in the composite vessel is to provide containment, and it is often composed of polymers such as medium density polyethylene (MDPE), high density polyethylene (HDPE), polyaramids (PA), or even aluminum in the case of Type III vessels. The construction of these vessel products follows with the use of carbon or other high-strength fiber reinforcement applied to the base tubular vessel to attain the desired final mechanical properties and primary pressure rating design criteria.

Tubular composites can be used to store liquids and gases, including but not limited to hydrogen, methane, hydrogen/methane blends, sour gas, and carbon dioxide. Tubular composites can be used to store a range of gases for use as fuel, including, but not limited to, LP gas, butane, diesel, gasoline, kerosene, biokerosene, jet fuel, aviation gasoline, naptha, and mineral spirits, as well as oxygenated compounds, including alcohols such as methanol and ethanol. Tubular composites can be assembled by sequential application of materials onto the exterior of a cantilevered cylindrical mandrel, while drawing the finished tubular composite down the length of the mandrel.

In principle, a tubular composite can have any size; however, manufacture of larger tubular composites can be problematic. In order to increase the diameter of the tubular composite, a larger diameter mandrel is required, which may not be easily feasible. The length of the tubular composite can be increased by extending the manufacturing process; however, an extremely long cylindrical structure can be unwieldy and inefficient. The practical limits on both diameter and length impose an upper limit to the volume, and therefore capacity, of a single tubular composite.

Aside from potential manufacturing or engineering obstacles to their manufacture, storage facilities that rely on a single large-capacity tubular composite are not ideal, for several reasons. Repair of a defect or tear, regardless of its size, in the single tubular composite would require that the entire contents be discharged and the facility be taken offline. Even in the absence of such drastic events, reliance on a single tubular composite for prolonged storage is not optimal for supplies or offtakes that either take place frequently or involve large quantities of media. These operations can impose stresses, both thermal and mechanical, on the tubular composite, that can decrease the service lifetime of the facility.

Storage facilities that rely on a single large-capacity tubular composite are also limited to operating at a single pressure, which has multiple disadvantages. If the storage system supplies gas for multiple end use applications, it is likely that these applications will require supply at different pressures. When a storage system operates at a single pressure for multiple end uses, either additional compression and storage infrastructure is needed, or extra energy is wasted on unnecessary compression for the low pressure end use applications. In addition, storage facilities that rely on a single large-capacity tubular composite cannot readily upgrade their storage capacity, and a need exists for storage solutions to be constructed such that their storage capacity is easily expanded.

A storage facility containing a single tubular composite is only suitable for the storage of a single type of medium at a time. A change in the nature of the medium would be neither convenient nor quick, and during this change, the storage facility would be offline. Such a facility would not be readily able to vary the composition of the stored media, either due to short term effects, such as price fluctuations, and medium term effects such as differential seasonal demand for various fluids. Finally, such a facility may not be capable of adapting to long term trends, such as the expected transition from hydrocarbon-based fuels to “green” fuels, most notably hydrogen or CO2 for carbon capture, utilization, and storage (“CCUS”) activities. In this scenario, replacement of higher carbon intensity fuels such as natural gas with low carbon intensity fuels such as hydrogen may proceed in a continuous fashion, with hydrogen being blended into the natural gas at progressively higher levels, or could occur as a step change. For these reasons, a need exists for storage systems to remain agnostic to the existing and future liquids and gases being stored to the greatest extent possible.

There remains a need to provide storage facilities based on tubular composites with improved robustness, flexibility, and reliability.

### BRIEF SUMMARY

Accordingly, provided herein is a “gigavault” storage facility for liquids and/or gases that comprises a plurality of tubular composites. The capacity of each of the individual tubular composites can be relatively modest; however, the presence of a plurality of these tubular composites will afford the facility a substantial overall capacity.

The facility will further comprise a plurality of valves and related piping, which provides for the supply or offtake for a single tubular composite in the facility, or a group thereof.

Supply or offtake of individual tubular composite can be made possible by fitting each of the tubular composite with its own valve. Alternatively, supply or offtake of a group of tubular composites can be made possible by partitioning a manifold connected to the tubular composites into a plurality of sub-manifolds, each of which can be isolated from the remainder of the manifold by closing valves in the manifold's interior.

Optionally, the facility can also incorporate ventilation pathways for safe release of the stored fluid in specific situations. Ventilation pathways can be established by fitting each of the plurality of tubular composite with a vent valve and release path. Alternatively, a single ventilation pathway can be established as part of the manifold connecting the individual tubular composites. The ventilation system can be terminated with release of the gas into the ambient environment. Prior to release, the gas may be rendered inert through the use of a flare, or may otherwise be contained or reacted at the termination point of the vent system.

Due to the multiplicity of valves, an operator of the facility can choose a single tubular composite or a group of tubular composites for supply or offtake, thereby providing granular control over the nature and amount of contents in each of the plurality of tubular composites.

Due to the multiplicity of valves and connections to the storage, an operator of the facility may also choose to provide multiple levels of pressure within the storage system, providing control over the pressure of the fluid being delivered to the downstream application.

The facility can also comprise a gas management center, which provides the necessary controls and components for driving the transfer of media to and from the tubular composites. In addition, the gas management center can also provide a means of generation of the fluid(s) to be stored in the tubular composites through methods such as electrolysis or steam methane reforming.

The facility can optionally provide a health and risk monitoring system (“HRMS”), preferably but not necessarily located in the gas management center. The HRMS can collect telemetry data from one or more sensors located on the vault site, some or all of which may be embedded in the tubular composite, and can therefore serve as a centralized resource for observing and documenting the health of each of the plurality of tubular composites. The HRMS can also perform control and safety actions on the system as well as notify operators if an out-of- bounds condition is encountered. Parameters that might be collected from individual tubular composites and reported at the HRMS can include, but are not limited to, pressure (both static and cyclic), temperature (both static and cyclic), strain on the tubular composite, flow of media during both injection and withdrawal, and mass of media. Sensors for collection of these parameters are most conveniently, but not necessarily, embedded in individual tubular composite. The HRMS may also collect data on events in and around the vault that might indicate an impending risk to the facility, including reporting on leaks, seismic activity, and digging.

The plurality of tubular composites is disposed so as to make efficient use of the footprint of land. Equipping the gigavault facility with identical sized tubular composites may simplify its operation. However, utilization of tubular composites of varying sizes and installation methods is also contemplated with this disclosure, which may be advantageous for irregularly shaped tracts of land or the need for specific storage capacities in proximity to producing/consuming assets at the site. The ability to manufacture tubular composites of various lengths will facilitate provisioning of these facilities with non-uniform tubular composites.

In one aspect, the facility may contain a plurality of tubular composites, each of which is provided in a spiral geometry. The facility may contain one or more groups of two or more horizontally oriented spiral tubular composite arranged in a vertical stack. Individual spiral tubular composites or stacks thereof may be arranged in a horizontal grid pattern.

In one aspect, the facility may contain a plurality of tubular composites, each of which is provided with a linear geometry. The linear tubular composites may be oriented horizontally or vertically. The oriented linear tubular composites may optionally be partially or fully embedded in the ground. The linear tubular composite may be arranged in a grid pattern.

In one aspect, the facility may contain a plurality of tubular composites, each being provided with a semicircular or U-shaped geometry, the plurality of tubular composites being arranged in the facility with an approximately concentric orientation, with tubular composite of smaller radius being surrounded by tubular composites of larger radius. In this configuration, a gas management center can occupy the center of the innermost arc, in close proximity to the lengths of the tubular composites and the associated fittings.

In the various configurations for the plurality of tubular composites, particularly for configurations in which the tubular composites are partially or fully embedded in the ground, the space above the tubular composites can be employed for additional purposes, for example, solar power farms.

Aside from circumventing various manufacturing or engineering challenges, a storage facility containing multiple tubular composites can provide additional benefits. Most significantly, the operator will be able to control the state of discrete subsets of tubular composites or, in some embodiments, individual tubular composites. Supply and offtake operations can be limited to a fraction of the tubular composites in the facility, thereby sparing the remainder of the tubular composites from thermal or mechanical stress due to the transfer of media. Furthermore, in the event that a single tubular composite needs to be taken out of operation for servicing or repair, the remainder of the facility can be kept in operation. Individual tubular composites or groups of tubular composites can be operated at different pressures, thereby providing specific pressure targets for multiple downstream applications supplied by the storage system. Finally, individual tubular composites or groups of tubular composites can be provisioned with different media, thereby responding to market conditions or to global trends to a hydrogen-based “green” economy.

### BRIEF DESCRIPTION OF THE DRAWINGS

A full understanding of the invention can be gained from the following description of the preferred embodiments when read in conjunction with the accompanying drawings in which:

FIG. 1A depicts a TC and its constituent layers;

FIG. 1B depicts a TC adapted for placement in the ground;

FIG. 1C depicts a schematic for a partially embedded TC;

FIG. 2 depicts a storage facility comprising a “pitchfork” layout of horizontally oriented linear TC's, according to an aspect of the disclosure;

FIG. 3 depicts a storage facility comprising a “silo” layout of linear TC's, consisting of a single row of vertically oriented linear TC's, according to an aspect of the disclosure;

FIG. 4 depicts a storage facility comprising a “silo” layout of linear TC's, consisting of a single row of vertically oriented linear TC's and two manifolds, according to an aspect of the disclosure;

FIG. 5 depicts a storage facility comprising a “silo” layout of linear TC's, consisting of two rows of vertically oriented linear TC's, according to an aspect of the disclosure;

FIG. 6 depicts a storage facility comprising a “candlestick” layout of horizontally oriented curved TC's, according to an aspect of the disclosure;

FIG. 7A depicts the PMP in its linear state;

FIG. 7B depicts the PMP with a large radius of curvature;

FIG. 7C depicts the PMP with a medium radius of curvature;

FIG. 7D depicts the PMP with a small radius of curvature; and

FIG. 8A depicts configuration of the PMP during manufacture of a TC intended for a “candlestick” layout in an initial linear phase; FIG. 8B depicts configuration of the PMP during manufacture of a TC intended for a “candlestick” layout curved for manufacture of turn; FIG. 8C depicts configuration of the PMP during manufacture of a TC intended for a “candlestick” layout in a subsequent linear phase.

Components in each of these drawings are not necessarily drawn to scale.

### DETAILED DESCRIPTION OF PREFERRED EMBODIMENTS

Accordingly, provided herein is a facility for storing liquids or gases, the facility comprising:
a plurality of tubular composites, each having two tube ends, wherein:
   to each of the two tube ends is connected a device chosen from a terminus and a fitting, and
   at least one of the two tube ends is connected to a fitting;
a first manifold connected to a fitting of one or more of the plurality of tubular composites, each optionally via a closable valve; and
a first supply/offtake port connected to the first manifold, optionally via a closable valve.

In some embodiments, the first manifold is connected to a fitting of one or more of the plurality of tubular composites, each via a closable valve. In some embodiments, the first manifold is connected to a fitting of each of the plurality of tubular composites, each optionally via a closable valve. In some embodiments, the first manifold is connected to a fitting of each of the plurality of tubular composites, each via a closable valve. In some embodiments, the first manifold is connected to each of the fittings, each via two closable valves positioned in series with an intervening pipe segment. In some embodiments, the first manifold further comprises bleed valves on the intervening pipe segments between each of the two closable valves positioned in series.

In some embodiments, the first manifold further comprises one or more closable valves which, in the closed state, prevent fluid communication between one or more tubular composites and the first supply/offtake port.

In some embodiments, the first manifold is partitioned into one or more sub-manifolds by the inclusion of one or more closable valves capable of isolating a plurality of tubular composites from the remaining set of tubular composites connected to the first manifold.

In some embodiments, the facility further comprises:
a second manifold connected to a fitting of one or more of the plurality of tubular composites, each optionally via a closable valve; and
a second supply/offtake port connected to the second manifold, optionally via a closable valve.

In some embodiments, the second manifold is connected to a fitting of one or more of the plurality of tubular composites, each via a closable valve. In some embodiments, the second manifold is connected to a fitting of each of the plurality of tubular composites, each optionally via a closable valve. In some embodiments, the second manifold is connected to a fitting of each of the plurality of tubular composites, each via a closable valve. In some embodiments, the second manifold is connected to each of the fittings, each via two closable valves positioned in series with an intervening pipe segment. In some embodiments, the second manifold further comprises bleed valves on the intervening pipe segments between each of the two closable valves positioned in series.

In some embodiments, a fitting of each of the plurality of TC's is connected either to the first manifold, or the second manifold, or both. In some embodiments, at least one of the plurality of TC's is connected to both the first manifold and the second manifold via a tee valve, which allows fluid communication between the TC and either the first manifold or the second manifold. In some embodiments, each of the plurality of TC's is connected to both the first manifold and the second manifold via a tee valve.

In some embodiments, the second manifold further comprises one or more closable valves which, in the closed state, prevent fluid communication between one or more tubular composites and the second supply/offtake port.

In some further embodiments, the second manifold is partitioned into one or more sub-manifolds by the inclusion of one or more closable valves capable of isolating a plurality of tubular composites from the remaining set of tubular composites connected to the second manifold.

In some further embodiments, the group of closable valves connecting the one or more fittings to the first manifold or the second manifold can be configured so that none of the plurality of tubular composites is in fluid communication with both the first manifold and the second manifold.

In some further embodiments, the group of closable valves connecting the one or more fittings to the first manifold or the second manifold, the one or more closable valves of the first manifold, when present, and the one or more closable valves of the second manifold, when present, can be configured so that none of the plurality of tubular composites is in fluid communication with both the first manifold and the second manifold.

In some embodiments, each of the plurality of tubular composites is provided with a spiral geometry. In some further embodiments, the plurality of spiral TC's is grouped into array elements, each array element containing a single TC or a vertical stack of a plurality of TC's. In some further embodiments, the array elements form a rectangular or hexagonal motif.

In some embodiments, each of the plurality of tubular composites is provided with a linear geometry with horizontal orientation. In some further embodiments, each of the plurality of horizontal linear TC's is oriented parallel to the remaining TC's in the plurality of TC's. For brevity, this configuration is termed the “pitchfork” layout.

In some further embodiments, a tube end of each of the plurality of horizontal, parallel linear TC's is coplanar with a tube end of each of the remaining TC's in the plurality of TC's.

In some embodiments, each of the coplanar tube ends is connected to a fitting.

In some further embodiments, each of the tube ends of each of the plurality of horizontal, parallel linear TC's is coplanar with at least one tube end of the remaining TC's in the plurality of TC's. In some further embodiments, the plurality of horizontal linear TC's is grouped into array elements, each array element containing a single TC or a vertical stack of a plurality of TC's. In some further embodiments, the array elements form a rectangular motif.

In some embodiments, each of the plurality of tubular composites is provided with a linear geometry with vertical orientation.

In some further embodiments, each of the plurality of vertical linear TC's is oriented parallel to the remaining TC's in the plurality of TC's. For brevity, this configuration is termed the “silo” layout.

In some further embodiments, a tube end of each of the plurality of vertical, parallel linear TC's is coplanar with a tube end of each of the remaining TC's in the plurality of TC's. In some embodiments, each of the coplanar tube ends is connected to a fitting.

In some embodiments, each of the plurality of tubular composites is provided with an approximately semicircular geometry with a horizontal orientation. The TC's need not be perfectly or even substantially semicircular. TC's in this grouping are generally characterized in having fittings at either end. In some further embodiments, the TC's can be arranged in order of decreasing size, thereby forming a nested set of TC's. Preferably, the geometry of the resulting set of TC's is such that all of the fittings, i.e. each of the two fittings of each of the plurality of TC's, are collinear, thereby providing simplified connections.

In some embodiments, each of the plurality of TC's has an arc geometry. The arc length is without limit, but is preferably semicircular, making efficient use of an available site and allowing approximately collinear location of the two termini of each TC.

In some embodiments, each of the plurality of TC's consists of five runs: three substantially linear runs of TC, with a central linear run connected to two outer linear runs via curved “elbow” runs. Each of the runs may be fabricated individually, with the runs joined in a subsequent step; preferably, the entire TC is fabricated as a whole, with curvature introduced as needed during manufacture. The arc length of the two curved runs is without limit, but is preferably quarter-circular, making efficient use of an available site and thereby orienting the outer linear runs parallel to each other.

For brevity, configurations having TC's with either the arc geometry or the five-run geometry, is termed the “candlestick” layout.

In some embodiments, the TC's form a rectangular or hexagonal motif.

Also contemplated with this disclosure are gigavaults having TC's of differing geometries. From simple geometric packing considerations, a group of objects having the same or similar shapes will be expected to occupy an available site more efficiently than a group of objects with disparate shapes. However, some sites and usages, including but not limited to irregularly shaped sites, variations in terrain, in particular variations in suitability for trenches or boreholes, and anticipated storage of different media, may lend themselves to gigavaults having a combination of geometric layouts.

In some embodiments, the facility comprises:
one or more tubular composites, each provided with a linear geometry with horizontal orientation; and
one or more tubular composites, each provided with a linear geometry with vertical orientation.

In some embodiments, the facility comprises:
one or more tubular composites, each provided with a linear geometry; and
one or more tubular composites, each provided with a curved geometry.

In some embodiments, each of the plurality of tubular composites is located aboveground. In some embodiments, each of the plurality of tubular composites is embedded partially below ground. In some embodiments, each of the plurality of tubular composites is embedded fully below ground.

In some embodiments, each of the plurality of TC's is individually paired with and enclosed in a concentric cylindrical casing. In some embodiments, each of the TC/casing pairs is oriented horizontally. In some embodiments, each of the TC/casing pairs is oriented vertically. In some embodiments, each of the TC/casing pairs is positioned at least partially below ground. In some embodiments, each of the TC/casing pairs is positioned fully below ground. In some embodiments, the plurality of TC's is arranged in a silo layout.

In some embodiments, the inner diameter of the casing of each of the TC/casing pairs is larger than the TC, thereby forming a cylindrical annulus between the TC and the casing. In some embodiments, the cylindrical annulus is occupied by a sheath consisting of an attenuation gel.

In some embodiments, the facility comprises a plurality of horizontally oriented TC's embedded at least partially in the ground. In some embodiments, the plurality of horizontally oriented TC's is embedded fully in the ground. In some embodiments, the plurality of horizontally oriented TC's is arranged in either a pitchfork or silo layout. In some embodiments, each of the horizontally oriented TC's is partially or fully enclosed within a sheath consisting of an attenuation gel, in an interstitial space between the TC and the ground underneath, surrounding, and/or above the TC.

In some embodiments, the attenuation gel is compressible in at least one dimension. In some embodiments, the attenuation gel is compressible in three dimensions. In some embodiments, the attenuation gel at least partially absorbs vibrations external to the TC. In some embodiments, the attenuation gel is at least partially impermeable to gas, including but not limited to oxygen.

Also provided are embodiments wherein any embodiment above may be combined with any one or more of these embodiments, provided the combination is not mutually exclusive

Also provided herein is a method for the construction of a gigavault, the method comprising the steps of:
identifying an intended site for a tubular composite; and
appointing a TC at its intended site.

Also provided herein is a method for the construction of a gigavault, the method comprising the steps of:
identifying an intended site for a tubular composite;
forming a longitudinal depression in the ground at its intended site;
positioning a TC in the longitudinal depression, thereby locating the TC at least partially below ground and forming an empty interstitial space underneath, surrounding, and/or above the TC;
filling the empty interstitial space with a fluid precursor for an attenuation gel; and
curing the fluid precursor, thereby providing the attenuation gel.

Also provided herein is a method for the construction of a gigavault, the method comprising the steps of:
identifying an intended site for a tubular composite;
excavating a vertical borehole in the ground at its intended site;
positioning a cylindrical casing within the borehole;
positioning a TC in the cylindrical casing, thereby locating the TC at least partially below ground and forming an empty interstitial space underneath, surrounding, and/or above the TC;
filling the empty interstitial space with a fluid precursor for an attenuation gel; and
curing the fluid precursor, thereby providing the attenuation gel.

Also provided herein is any one of the aforementioned methods, further comprising the steps of:
providing a portable manufacturing platform (PMP); and
fabricating a tubular composite with the PMP.

Also provided herein is any one of the aforementioned methods, further comprising the steps of:
providing a portable manufacturing platform (PMP);
identifying an intended geometry for the TC;
identifying the locations of a first position and a second position suitable for fabrication of the TC with its intended geometry;
positioning the PMP at the location of the first position;
fabricating the TC with the PMP while advancing the PMP towards the location of the second position;
severing the TC from the PMP when the PMP reaches the location of the second position, thereby providing the TC with its intended geometry.

Unless explicitly indicated otherwise, methods which recite a set of steps for each of a plurality of TC's will be understood to embrace embodiments in which the set of steps for a first TC is performed at the same time as the set of steps for a second TC is performed.

Unless explicitly indicated otherwise, methods which recite a set of steps for each of a plurality of TC's will be understood to embrace embodiments in which the set of steps for a first TC is performed at a different time as the set of steps for a second TC is performed.

Stated differently, unless explicitly indicated otherwise, methods which recite a set of steps for each of a plurality of TC's will be understood to embrace embodiments which begin with performance of the set of steps for a first TC during a first time period, followed by performance of the set of steps for a second TC during a second time period, wherein the first time period and the second time period can be concurrent, overlapping, or non-overlapping.

Accordingly, provided herein is a method for the construction of a gigavault containing a plurality of tubular composites, the method comprising the steps of:
for each of the plurality of TC's:
   identifying an intended site for the TC; and
   appointing the TC at its intended site.

By way of example, the aforementioned method will be understood to embrace the following method for the construction of a gigavault containing two tubular composites, the method comprising the following steps, performed in the indicated order:
identifying an intended site for the first TC;
appointing the first TC at its intended site;
identifying an intended site for the second TC; and
appointing the second TC at its intended site.

Also by way of example, the aforementioned method will be understood to embrace the following method for the construction of a gigavault containing two tubular composites, the method comprising the following steps, performed in the indicated order:
identifying an intended site for the first TC;
identifying an intended site for the second TC;
appointing the first TC at its intended site; and
appointing the second TC at its intended site.

Also by way of example, the aforementioned method will be understood to embrace the following method for the construction of a gigavault containing a plurality of tubular composites, the method comprising the following steps:
for each of the plurality of TC's:
   identifying an intended site for the TC; and
   appointing the TC at its intended site;
wherein the intended sites for all of the plurality of TC's are identified before any of the plurality of TC's is provided at its intended site.

Also by way of example, and referring to the aforementioned method, the disclosure will be understood to contemplate a method for the construction of a gigavault containing a plurality of tubular composites, the method comprising the following steps:
for each of the plurality of TC's:
   identifying an intended site for the TC; and
   appointing the TC at its intended site;
wherein for each of the plurality of TC's is appointed at its intended site before the intended site for the immediately next TC, if any, is identified.

In some embodiments of the aforementioned method, each of the plurality of TC's is linear. In some embodiments, a terminus of each of the plurality of TC's is coplanar. In some embodiments, the intended site for each of the plurality of TC's is parallel to the intended sites for the remainder of the TC's. In some embodiments, the intended site for each of the plurality of TC's is oriented horizontally. In some embodiments, the intended site for each of the plurality of TC's is oriented horizontally, and the intended site for each of the plurality of TC's is coplanar. In some embodiments, the intended site for each of the plurality of TC's is oriented vertically. In some embodiments, the intended site for each of the plurality of TC's is oriented horizontally, and the intended site for each of the plurality of TC's forms a rectangular or hexagonal motif.

In some embodiments of the aforementioned method, each of the plurality of TC's is nonlinear. In some embodiments, each of the plurality of TC's consists of three substantially linear runs of TC, with a central linear run connected to two outer linear runs via curved runs. In some embodiments, the arc length of each of the two curved runs is quarter-circular, thereby orienting the outer linear runs parallel to each other. In some embodiments, the TC's can be arranged in order of decreasing size, with each TC, except for the largest TC, capable of being completely enclosed in the area defined by larger TC's in the plurality of TC's. In some embodiments, all of the termini of each of the plurality of TC's are collinear.

In some embodiments of the aforementioned method, each of the plurality of TC's is nonlinear. In some embodiments, each of the plurality of TC's has a substantially arclike geometry. In some embodiments, the arc length of the TC's is equal. In some embodiments, the arc length of the TC's is approximately 180°. In some embodiments, the plurality of TC's can be arranged in order of decreasing size, with each TC, except for the largest TC, capable of being completely enclosed in the area defined by larger TC's in the plurality of TC's. In some embodiments, all of the termini of each of the plurality of TC's are collinear.

Also provided herein is a method for the construction of a gigavault containing a plurality of tubular composites, the method comprising the steps of:
for each of the plurality of TC's:
   identifying an intended site for the TC;
   forming a longitudinal depression in the ground at the TC's intended site;
   positioning a TC in the longitudinal depression for the TC, thereby locating the TC at least partially below ground and forming an empty interstitial space underneath, surrounding, and/or above the TC;
   filling the empty interstitial space with a fluid precursor for an attenuation gel; and
   curing the fluid precursor, thereby providing the attenuation gel.

Also provided herein is a method for the construction of a gigavault containing a plurality of tubular composites, the method comprising the steps of:
for each of the plurality of TC's:
   identifying an intended site for the TC;
   excavating a vertical borehole in the ground at its intended site;
   positioning a cylindrical casing within the borehole;
   positioning a TC in the cylindrical casing, thereby locating the TC at least partially below ground and forming an empty interstitial space underneath, surrounding, and/or above the TC;
   filling the empty interstitial space with a fluid precursor for an attenuation gel; and
   curing the fluid precursor, thereby providing the attenuation gel.

Also provided herein is any one of the aforementioned methods for the construction of a gigavault containing a plurality of tubular composites, further comprising the steps of:
providing a portable manufacturing platform (PMP); and
for each of the plurality of TC's:
   fabricating a tubular composite using the PMP.

Also provided herein is any one of the aforementioned methods for the construction of a gigavault containing a plurality of tubular composites, further comprising the steps of:
providing a portable manufacturing platform (PMP); and
for each of the plurality of TC's:
   identifying an intended geometry for the TC;
   identifying the locations of a first position and a second position suitable for fabrication of the TC with its intended geometry;
   positioning the PMP at the first position;
   fabricating the TC with the PMP while advancing the PMP towards the location of the second position; and
   severing the TC from the PMP when the PMP reaches the location of the second position, thereby providing the TC with its intended geometry.

Also provided herein is a method for the construction of a gigavault, the method comprising the steps of:
providing a portable manufacturing platform (PMP);
identifying an intended site for a TC; and
fabricating a tubular composite with the PMP at its intended site.

Also provided herein is a method for the construction of a gigavault, the method comprising the steps of:
providing a portable manufacturing platform (PMP);
identifying an intended site for a TC;
identifying the intended locations of a first terminus and a second terminus for the TC;
positioning the PMP at the intended location of the first terminus;
fabricating the TC with the PMP while advancing the PMP towards the intended location of the second terminus; and
severing the TC from the PMP when the PMP reaches the intended location of the second terminus, thereby providing the TC at its intended site.

Also provided herein is a method for the construction of a gigavault, the method comprising the steps of:
providing a portable manufacturing platform (PMP);
identifying an intended site for the TC;
fabricating a tubular composite with the PMP; and
appointing the TC at its intended site.

In some embodiments, the intended sites for all of the plurality of TC's are identified before any of the plurality of TC's is fabricated. In some embodiments, all of the plurality of TC's are fabricated before any of the plurality of TC's is appointed to its intended site.

Also provided herein is a method for the construction of a gigavault, the method comprising the steps of:
providing a portable manufacturing platform (PMP);
identifying an intended site and an intended geometry for the TC;
identifying the locations of a first position and a second position suitable for fabrication of the TC with its intended geometry;
positioning the PMP at the first position;
subsequent to positioning the PMP at the first position, fabricating the TC with the PMP while advancing the PMP towards the second position;
subsequent to arrival of the PMP at the location of the second position, severing the TC from the PMP, thereby providing the TC with its intended geometry; and
appointing the TC at its intended site.

In some embodiments, intended sites and intended geometries for all of the plurality of TC's are identified before the intended location of either the first position or second position for any of the plurality of TC's is identified. In some embodiments, the intended locations of the first positions and second positions for all of the plurality of TC's are identified before the PMP is positioned at the first position for any of the plurality of TC's. In some embodiments, all of the plurality of TC's are provided with their intended geometry before any of the TC's is appointed to its intended site.

Also provided herein is a method for the construction of a gigavault containing a plurality of tubular composites, the method comprising the steps of:
providing a portable manufacturing platform (PMP); and
for each of the plurality of TC's:
   identifying an intended site for the TC; and
   fabricating a tubular composite using the PMP at its intended site.

Also provided herein is a method for the construction of a gigavault containing a plurality of tubular composites, the method comprising the steps of:
providing a portable manufacturing platform (PMP); and
for each of the plurality of TC's:
   identifying an intended site for the TC;
   identifying the intended locations of a first terminus and a second terminus for the TC;
   positioning the PMP at the intended location of the first terminus for the TC;
   subsequent to positioning the PMP at the first terminus, fabricating the TC with the PMP while advancing the PMP towards the intended location of the second terminus for the TC; and
   subsequent to arrival of the PMP at the location of the second terminus, severing the TC from the PMP, thereby providing the TC at its intended site.

In some embodiments, the intended sites for all of the plurality of TC's are identified before the intended location of either the first terminus or the second terminus for any of the plurality of TC's is identified. In some embodiments, the intended locations of the first termini and second termini for all of the plurality of TC's are identified before the PMP is positioned at the first position for any of the plurality of TC's.

Also provided herein is a method for the construction of a gigavault containing a plurality of tubular composites, the method comprising the steps of:
providing a portable manufacturing platform (PMP); and
for each of the plurality of TC's:
   identifying an intended site for the TC;
   fabricating a tubular composite using the PMP; and
   appointing the TC at its intended site.

Also provided herein is a method for the construction of a gigavault containing a plurality of tubular composites, the method comprising the steps of:
providing a portable manufacturing platform (PMP); and
for each of the plurality of TC's:
   identifying an intended site and intended geometry for the TC;
   identifying the locations of a first position and a second position suitable for fabrication of the TC with its intended geometry;
   positioning the PMP at the first position;
   fabricating the TC with the PMP while advancing the PMP towards the second position;
   severing the TC from the PMP when the PMP reaches the second position, thereby providing the TC with its intended geometry; and
   appointing the TC at its intended site.

Also provided herein is a method for the construction of a pitchfork gigavault containing a plurality of tubular composites, the method comprising the steps of:
providing a portable manufacturing platform (PMP);
configuring the PMP for fabrication of a linear TC; and
for each of the plurality of TC's:
   identifying an intended site for the TC;
   identifying the intended locations of a first terminus and a second terminus for the TC;
   positioning the PMP at the intended location of the first terminus for the TC;
   fabricating the TC with the PMP while advancing the PMP towards the intended location of the second terminus for the TC; and
   severing the TC from the PMP when the PMP reaches the intended location of the second terminus, thereby providing the TC at its intended site.

Also provided herein is a method for the construction of a silo gigavault containing a plurality of tubular composites, the method comprising the steps of:
providing a portable manufacturing platform (PMP);
configuring the PMP for fabrication of a linear TC; and
for each of the plurality of TC's:
   identifying an intended site and intended geometry for the TC;
   identifying the locations of a first position and a second position suitable for fabrication of the TC with its intended geometry;
   positioning the PMP at the first position;
   fabricating the TC with the PMP while advancing the PMP towards the second position;
   severing the TC from the PMP when the PMP reaches the second position, thereby providing the TC with its intended geometry;
   excavating a vertical borehole in the ground at its intended site;
   positioning a cylindrical casing within the borehole;
   positioning a TC in the cylindrical casing, thereby locating the TC at least partially below ground and forming an empty interstitial space underneath, surrounding, and/or above the TC;
   filling the empty interstitial space with a fluid precursor for an attenuation gel; and
   curing the fluid precursor, thereby providing the attenuation gel.

In some embodiments, vertical boreholes for all of the plurality of TC's are excavated before a cylindrical casing is positioned within the borehole for any of the plurality of TC's. In some embodiments, cylindrical casings are positioned within the borehole for all of the plurality of TC's before any of the plurality of TC's is positioned in a cylindrical casing. In some embodiments, all of the plurality of TC's are positioned in cylindrical casings before the empty interstitial space for any of the plurality of TC's is filled with a fluid precursor. In some embodiments, the empty interstitial space for all of the plurality of TC's is filled with a fluid precursor before the fluid precursor in the interstitial space for any of the plurality of TC's is cured.

Also provided herein is a method for the construction of a candlestick gigavault containing a plurality of tubular composites, the method comprising the steps of:
providing a portable manufacturing platform (PMP); and
for each of the plurality of TC's:
   identifying an intended site for the TC;
   identifying the intended locations of a first terminus and a second terminus for the TC;
   configuring the PMP for fabrication of a curved TC;
   positioning the PMP at the intended location of the first terminus for the TC;
   fabricating the TC with the PMP while advancing the PMP towards the intended location of the second terminus for the TC; and
   severing the TC from the PMP when the PMP reaches the intended location of the second terminus, thereby providing the TC at its intended site.

Also provided herein is a method for the construction of a candlestick gigavault containing a plurality of tubular composites, the method comprising the steps of:
providing a portable manufacturing platform (PMP); and
for each of the plurality of TC's:
   identifying an intended site for the TC;
   identifying the intended location of a first terminus and a second terminus;
   identifying the intended location of an endpoint for a first linear run;
   configuring the PMP for fabrication of a linear TC;
   positioning the PMP at the intended location of the first terminus for the TC;
   fabricating the TC with the PMP while advancing the PMP towards the intended location of the endpoint for the first linear run;
   identifying the intended location of an endpoint for a first curved run;
   configuring the PMP for fabrication of a curved TC;
   fabricating the TC with the PMP while advancing the PMP towards the intended location of the endpoint for the first curved run;
   identifying the intended location of an endpoint for a second linear run;
   configuring the PMP for fabrication of a linear TC;
   fabricating the TC with the PMP while advancing the PMP towards the intended location of the endpoint for the second linear run;
   identifying the intended locations of an endpoint for a second curved run;
   configuring the PMP for fabrication of a curved TC;
   fabricating the TC with the PMP while advancing the PMP towards the intended location of the endpoint for the second curved run;
   identifying the intended location of an endpoint for a third linear run;
   configuring the PMP for fabrication of a linear TC;
   fabricating the TC with the PMP while advancing the PMP towards the intended location of the endpoint for the third linear run; and
   severing the TC from the PMP when the PMP reaches the intended location of the second terminus, thereby providing the TC at its intended site.

Also provided herein is a method for the storage of a fluid, comprising the step of provisioning a facility as disclosed herein with the fluid.

In some embodiments, the fluid is a gas. In some embodiments, the gas is a pressurized gas. In some embodiments, the gas is chosen from hydrogen, natural gas, a hydrogen/natural gas mixture, carbon dioxide, and sour gas.

In some embodiments, the fluid is a supercritical fluid.

### Definitions

The term “tubular composite” (“TC”), as used herein, refers generally to a tubular vessel that is suitable for storage of liquids or gases, or mixtures thereof, that includes a composite of two or more individual concentric tubular members, manufactured to form an overall tubular structure. A tubular composite may have a substantially cylindrical geometry, and may generally have tube ends at either end of the tubular composite. A tube end may be equipped with a terminus, providing a seal across the otherwise open end. Alternatively, a tube end may be equipped with a fitting, which may include a closable valve, allowing a connection to a pipe or other means for conveying fluid or another piece of equipment such as a gauge. Examples of tubular composites are disclosed in US Patent Application Publication US20220143948(A1), published 12 May 2022, incorporated herein by reference and in US Patent Application Publication US20220412511(A1), published 29 Dec. 2022, incorporated herein by reference.

The term “gigavault”, as used herein, refers generally to a facility that comprises a plurality of tubular composites, as defined herein, wherein at least one of the tube ends of each tubular composite is connected to a fitting, thereby providing a means to transfer fluid into or out of the tubular composite. The gigavault also comprises at least a first manifold providing connections, via supply/offtake ports, to a subset of, or all of, the tubular composites. The gigavault can comprise additional manifolds, each of which is generally isolated from the remaining manifolds, and each of which can provide connections to a subset of, or all of, the tubular composites. The subsets of tubular composites need not be identical; however, each tubular composite will be connected to at least one manifold.

The term “closable valve”, as used herein, refers to a valve mounted on the which can be driven to a closed state that blocks fluid communication between structures on either side of the closable valve. Substitution of any and all closable valves in an embodiment with any one of the following: (a) a pair of closable valves in series, with an intervening pipe section; (a) a pair of closable valves in series, with an intervening pipe section having a bleed valve attached thereto; or (c) a double block and bleed valve is within the scope of this disclosure.

Directional phrases used herein, such as, for example and without limitation, top, bottom, left, right, up, down, upper, lower, front, back, and derivatives thereof, relate to the orientation of the elements shown in the drawings and are not limiting upon the claims unless expressly recited therein.

In some embodiments, the tubular composite comprises an innermost cylindrical layer which is impermeable to passage of fluid. In some embodiments, the tubular composite comprises an outermost cylindrical layer, which provides protection from external mechanical events.

In some embodiments, the tubular composite comprises one or more axial reinforcement layers which provides strength in the axial direction. In some further embodiments, the one or more axial reinforcement layers comprises fibers aligned in the axial direction.

In some embodiments, the tubular composite comprises one or more hoop reinforcement layers which provides strength in the radial (hoop) direction. In some further embodiments, the one or more hoop reinforcement layers comprises fibers aligned in a helical configuration.

In general, the design, composition, and manufacture of the tubular composite is without limit. Certain tubular composites may have a substantially monolithic composition. Preferably, tubular composites have a layered structure, with each layer satisfying a function, such as permeation resistance, strength in various directions, resistance to puncture and tears, chemical resistance, and protection from external threats.

Certain tubular composites contain sensor arrays, either applied to the interior or exterior wall of the tubular composite or incorporated into a discrete layer. The sensor arrays can provide data acquisition capabilities for instantaneously reporting changes in, for example, temperature, pressure, flow, tension, fatigue, wall thickness, and/or corrosion, as well as other acoustic indicators such as movement due to events caused by, for example, seismic activity and approaching third-party activities. The embedded sensor array can provide continuous monitoring of the tubular composite structure for structural health. The term “innervated tubular composite” may be used to refer to this type of sensor containing tubular composite, reflecting their ability to continuously monitor the condition of the tubular composite, thereby protecting it from damage, maintaining safe operations, and/or extending operating lifetime. The sensor arrays may be provided in the form of a sensor array layer. The sensor array layer may be embedded on the exterior of either a hoop reinforcement layer, an axial reinforcement layer, or a protective layer. Alternatively, the sensor array layer may be located on the exterior surface of the scaling layer. Multiple sensor arrays may be implemented within the same or differing layers of the composite structure for a given installation.

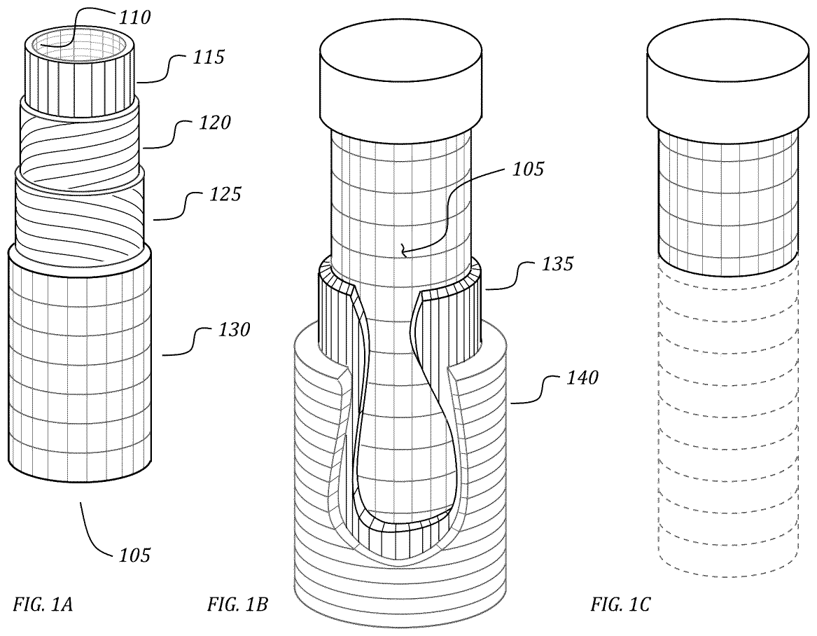

Depicted in FIG. 1A is a tubular composite (“TC”) 105, according to an aspect of the disclosure. TC 105 is intended to represent a typical tubular composite that may be utilized in various aspects of the disclosed concept and is not intended to be limiting. In some embodiments, certain layers of TC 105 may be varied or omitted. In some embodiments, the location of certain layers of TC 105 may be changed. In some embodiments, additional layers may be included in TC 105.

TC 105 includes a sealing layer 110. Sealing layer 110 generally serves to provide chemical resistance and impermeability to the contents of TC 105. In certain embodiments, sealing layer 110 may comprise a coating on either the interior or exterior surface thereof, but most optimally on the inside surface of TC 105 in order to further prevent escape of media from TC 105 and/or to provide mechanical strength to TC 105. Sealing layer 110 may comprise a coextruded foil composed of a variety of metals such as aluminum or beta silicon carbide. Sealing layer 110 is generally fabricated from a plastic sheet stock and coextrusions thereof, including but not limited to coextruded and/or reinforced and/or non-reinforced thermoplastics, thermosets, fluoropolymers or biobased plastics.

TC 105 also includes an axial reinforcement layer 115 that is intended to provide longitudinal strength and can be fabricated from a material chosen from polyethylene infused carbon fiber that is twisted under specific torsional load, thereby forming tows comprising twisted rope-like threads. These individual twisted rope threads are then bonded together with polyethylene or EVA to form a flat tape (“micro-rope”) containing as few as one twisted rope or as many as 200 or more twisted ropes in one “micro-rope” tape section. Alternative materials for the axial reinforcement layer include, but are not limited to, graphene hybrid micro-rope, unidirectional carbon fiber, glass fiber micro-rope, Kevlar micro-rope, aramid fiber micro-rope, and polyethylene fiber micro-rope. The specific torsional loading/twisting of these materials significantly increases the breaking efficiency thus increasing the breaking strength proportionately.

In some embodiments, axial reinforcement layer 115 is fabricated from a material chosen from aramid fiber, unidirectional fiberglass, carbon fiber, Kevlar, or HDPE fabric which has been pre-impregnated with a material chosen from epoxy, polyurethane, polyolefin, and EVA.

One or more hoop reinforcement layers may be incorporated as part of TCs of the disclosed embodiment to provide mechanical strength against circumferential (hoop) stress. The number of hoop layers applied is directly proportional to the resistance of required internal pressure and design (safety) factor. TC 105 depicted in FIG. 1A contains two hoop reinforcement layers 120 and 125, wound with opposite helicity.

In some embodiments, any or all of the one or more hoop reinforcement layers can be fabricated from a material chosen from polyethylene infused carbon fiber that is twisted under specific torsional load, thereby forming tows comprising twisted rope-like threads. These individual twisted rope-like threads are then bonded together with polyethylene or EVA to form a flat tape (“micro-rope”) containing as few as one twisted rope or as many as 200 or more twisted ropes in one “micro-rope” tape section.

Alternatively, any or all of the one or more hoop reinforcement layers can be fabricated from a material chosen from graphene hybrid micro-rope, unidirectional carbon fiber, glass fiber micro-rope, Kevlar micro-rope, aramid fiber micro-rope, and polyethylene fiber micro-rope. The specific torsional loading/twisting of these materials significantly increases breaking efficiency, thus increasing the breaking strength proportionately.

In some embodiments, any or all of the one or more hoop reinforcement layers can be fabricated from a material chosen from twisted carbon fiber tow, graphene hybrid micro-rope, unidirectional carbon fiber, glass fiber, Kevlar, aramid fiber, and polyethylene fiber.

The outermost layer of the representative TC 105 depicted in FIG. 1A is a protective layer 130, which generally serves to provide overall protection from external actions and agents. The protective layer can be fabricated from plastic with fiber or aramid reinforcement. The material can have high slip, abrasion or puncture resistance properties. The material can provide increase ring stiffness and buckling resistance to TC 105. In some embodiments, protective layer 130 comprises a material chosen from nylon, tear-resistant PTFE, coated fiberglass fabric, and polyethylene. Protective layer 130 can further comprise Kevlar for puncture resistance and threat protection. Protective layer 130 can be compressed after application, for example using heat, thereby immobilizing one or more components below the protective layer.

In some embodiments of the disclosed concept as described herein, tubular composites are fitted into boreholes in a silo layout. Additional protection may be used for tubular composites in this configuration. FIG. 1B depicts TC 105 further contained within a sheath 135 comprising an attenuation gel which can serve as a barrier to oxygen and/or a reinforcement against seismic activity. TC 105 and sheath 135 may be further contained in a concentric casing 140.

Also depicted in FIG. 1B is a terminus that is positioned at the top of TC 105. At least one of the two ends of TC 105 will be provided with a fitting to provide access for supply and offtake. Preferably, but not necessarily, each TC 105 will further be provided a closable valve, which in its closed state blocks fluid communication between TC 105 and any remaining TCs 105 in a facility as described herein. In some embodiments, each TC 105 will further be provided with two closable valves, positioned in series with an intervening pipe segment, wherein when either of the two closable valves is in its closed state, fluid communication between TC 105 and any remaining TCs 105 in the facility is blocked. In some embodiments as described herein, the facility further comprises bleed valves on the intervening pipe segments between two closable valves positioned in series.

The disclosed concept also contemplates the use of a portable manufacturing platform (“PMP”) for manufacture of tubular composites, such as TCs 105. US Patent Application Publication US20220143948(A1), published 12 May 2022 and incorporated herein by reference, discloses a mobile onsite factory (“MOF”) which can serve as the PMP envisioned herein. US Patent Application Publication US20220412511(A1), published 29 Dec. 2022 and incorporated herein by reference, discloses a related autonomous manufacturing vehicle (“AMV”) which can serve as the PMP envisioned herein.

The PMP is a mobile vehicle that can progressively manufacture a tubular composite, such as TC 105, from its constituent materials. The PMP allows for the manufacture of tubular composites on-site, thereby removing the need to transport tubular composites from a remote factory. The PMP can be supplied with the constituent materials which, in some embodiments, can be provided on spools. It will be appreciated that an assembled tubular composite is likely to be relatively rigid and will resist structural deformation-properties which enhance the suitability of the tubular composite but which hamper its transportability. However, the individual constituent materials may be flexible and readily transportable.

In one mode of operation of the PMP, the vehicle is first positioned at the intended location of a first terminus for tubular composite that is to be positioned horizontally. Manufacture of the tubular composite is begun, with the initially formed end of the tubular composite being properly positioned at the intended location of its first terminus. As the tubular composite is progressively manufactured, the PMP moves towards the intended location of a second terminus for the horizontal tubular composite. In the exemplary embodiment, the horizontal speed of the PMP matches the rate at which the growing tubular composite is formed, thereby leaving a stationary, growing tubular composite in its wake. In some embodiments, the PMP moves in a linear direction, thereby fabricating a linear tubular composite. In some embodiments, the PMP moves in a curved direction, thereby fabricating an arc-like tubular composite. In some embodiments, the PMP can be reconfigured during fabrication of a single tubular composite, thereby varying the geometry of the nascent tubular composite at any stage of fabrication, from linear to curved. In some embodiments, the PMP can be reconfigured during fabrication of a single tubular composite, thereby varying the radius of curvature of the nascent tubular composite at any stage of fabrication. Combinations of the two motions are possible, which can be used to fabricate tubular composites with one or more linear sections and one or more arc-like sections, such as those envisioned for the “candlestick” layout that is described elsewhere herein. The ability to alter the turn radius of the PMP during fabrication provides a method for manufacture of tubular composites such as these that have varied geometry while being structurally continuous and intact. Existing methods that require individual manufacture of e.g. linear and curved segments would necessarily require joining the segments to form the final tubular composite, thereby adding complexity and potentially introducing a site of future vulnerability. Once the PMP reaches the intended location of the second terminus, the now-completed tubular composite is severed from the PMP, thereby providing the tubular composite at its intended site.

In some embodiments, the tubular composite can be progressively manufactured so as to be properly located at the completion of its manufacture. In other embodiments, this may not be required, or even desirable. For example, manufacture of tubular composites intended for eventual vertical siting may be initially manufactured with a horizontal geometry in a suitable staging area, then positioned vertically upon completion.

Depicted in FIG. IC is a compact representation of a vertically oriented TC 105 embedded partially in the ground. It will be understood that, for maximum protection, the entirety of TC 105 may be embedded in the ground, with only an upper fitting readily accessible for service.

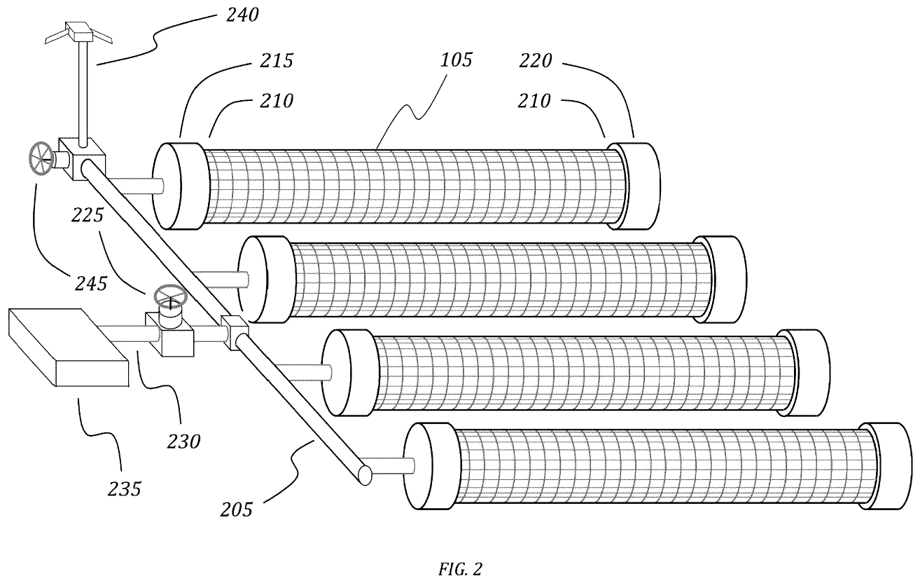

Depicted in FIG. 2 is a storage facility comprising a “pitchfork” layout according to an exemplary embodiment of the disclosed concept. The facility contains four horizontally oriented TCs 105, and a manifold 205. Each of the four TCs 105 has two tube ends 210, with the proximal end connected to a fitting 215, and the distal end connected to a terminus 220. Each of the four fittings 215 is connected to manifold 205, which in turn is connected via exterior valve 225 and supply/offtake port 230 to a gas management center 235, which for compactness is represented simply as a rectangular prism. Also included in this embodiment is a vent mast 240 that is connected to manifold 205 via a closable valve 245.

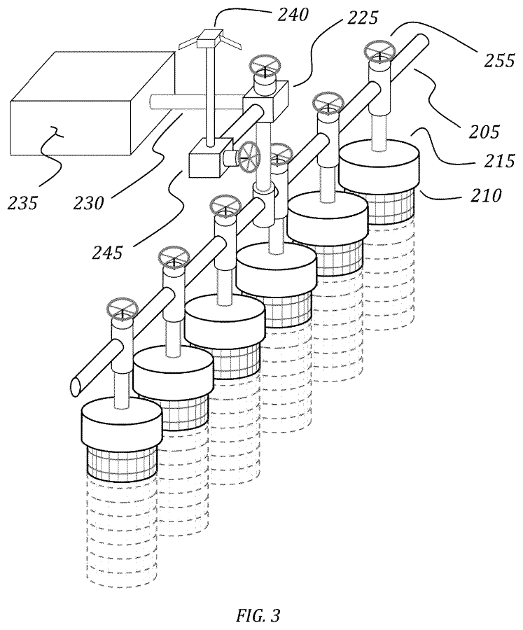

Depicted in FIG. 3 is a storage facility comprising a “silo” layout according to another exemplary embodiment of the disclosed concept. The facility contains six vertically oriented TCs 105 at least partially buried underground and a manifold 205. Each of the six TCs 105 has two tube ends 210, with the upper tube end connected to a fitting 215, and the lower tube end (obscured) connected to a terminus (obscured). Each of the six fittings 215 is connected to manifold 205 via a fitting valve 255. In turn, manifold 205 is connected via an exterior valve 225 and supply/offtake port 230 to gas management center 235. Also included in this embodiment is an optional vent mast 240 connected to manifold 205 via closable valve 245.

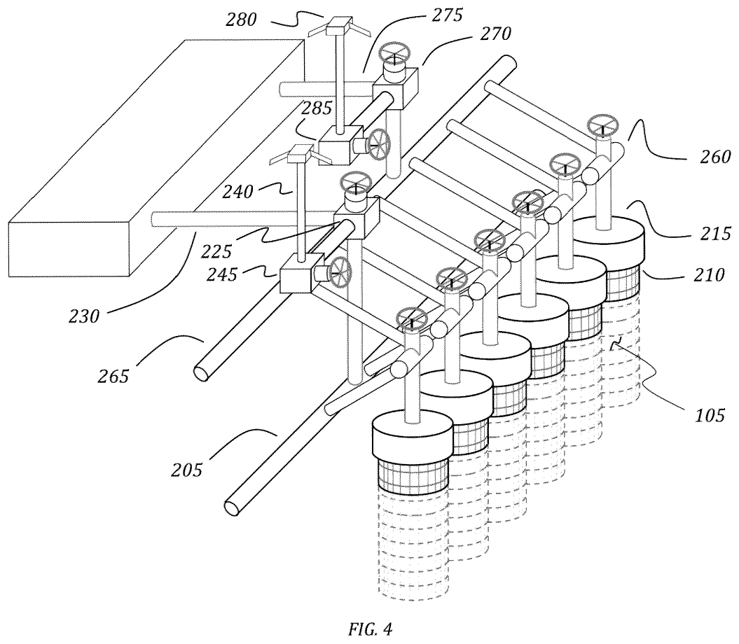

Depicted in FIG. 4 is a storage facility comprising a “silo” layout according to another alternative exemplary embodiment of the disclosed concept. The facility contains six vertically oriented TCs 105, each having a fitting 215 on the upper tube end 210. Each of the six fittings 215 is connected to a tee valve 260, which in turn allows connection to either a first manifold 205 or a second manifold 265. As with the facility depicted in FIG. 3, the first manifold 205 of the facility depicted in FIG. 4 is connected via a first exterior valve 225 and a supply/offtake port 230 to a gas management center 235. An optional vent mast 240 is connected to first manifold 205 via closable valve 245. The facility depicted in FIG. 4 further comprises the second manifold 265, which is connected via second a exterior valve 270 and a second supply/offtake port 275 to gas management center 235. An optional second vent mast 280 is connected to second manifold 265 via a second closable valve 285.

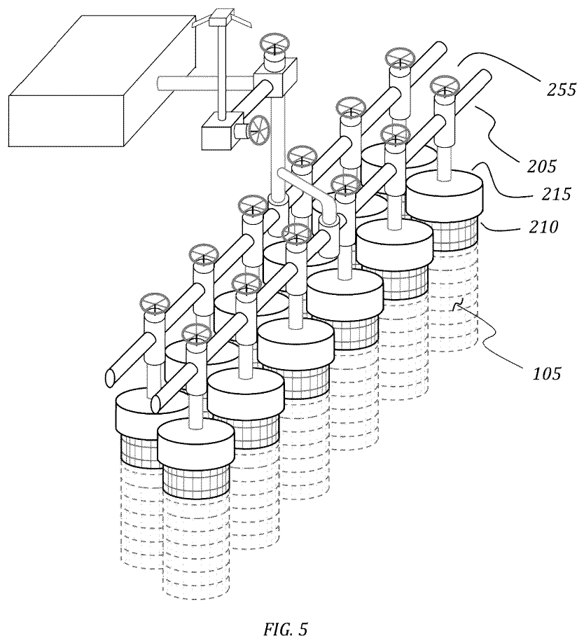

Depicted in FIG. 5 is a storage facility comprising a “silo” layout according to another alternative exemplary embodiment of the disclosed concept. As with the facility depicted in FIG. 3, the storage facility of FIG. 5 contains vertically oriented TCs 105, in this case in two banks of six TCs 105 each. Each of the twelve TCs 105 is connected via a fitting 215 and a fitting valve 255, mounted at an upper tube end 210, to a manifold 205. In turn, manifold 205 is connected via an exterior valve 225 and a supply/offtake port 230 to a gas management center 235. Also included in this embodiment is an optional vent mast 240 connected to a manifold 205 via a closable valve 245.

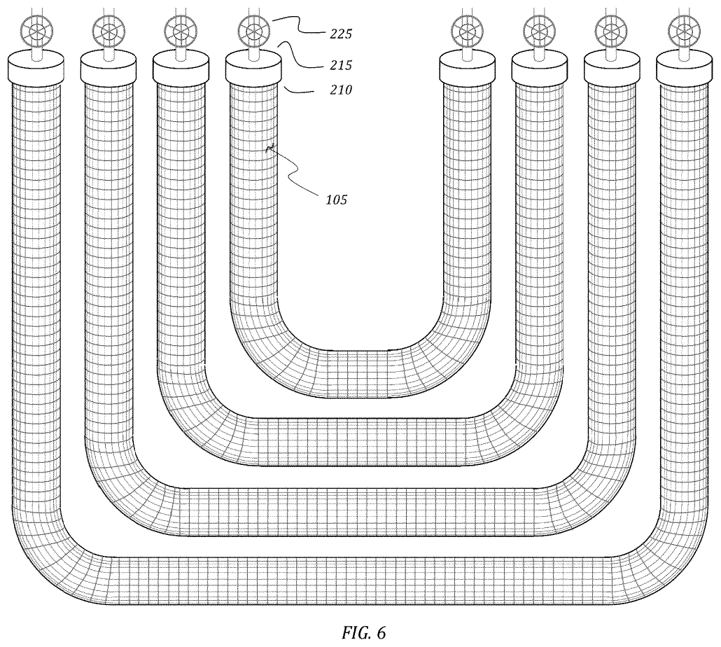

Depicted in FIG. 6 is a storage facility having a “candlestick” layout according to another alternative exemplary embodiment of the disclosed concept. The facility comprises four nested U-shaped TCs 105, each having a fitting 215 at each of the two tube ends 210 thereof. In turn, the eight fittings 215 can be connected via an exterior valve 225 to manifold 205 (not shown). In some embodiments, the gas management center may be located in the interior of the nested TCs 105. Depending on the length of the smallest radius of curvature that can be reasonably achieved for the manufacture of TCs 105, this configuration may help make efficient use of the entirety of the site for the facility.

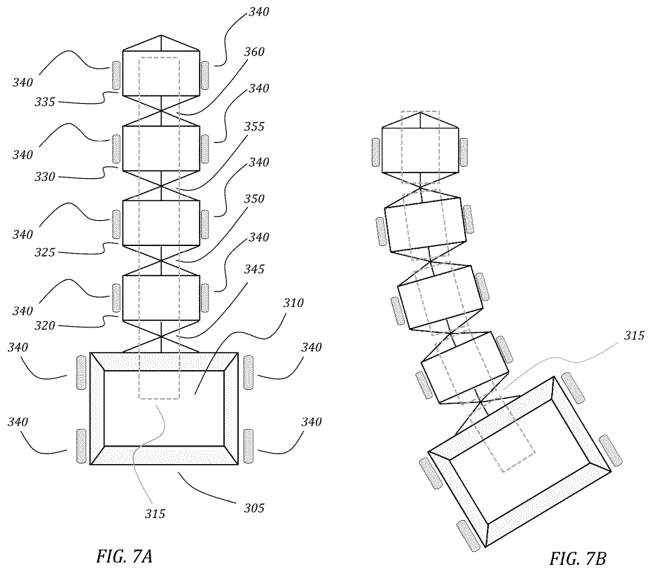

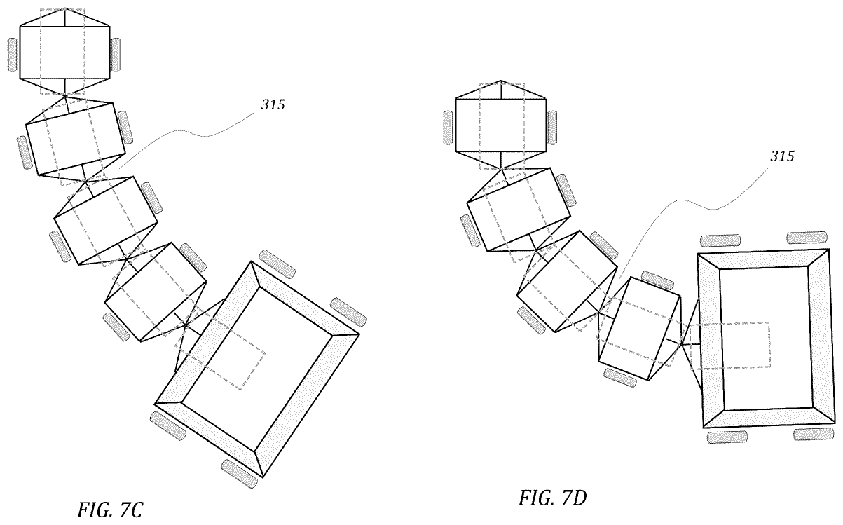

An exemplary PMP 305 is depicted in FIG. 7A. Manufacture of a tubular composite, like TC 105, is initiated at the bottom of PMP 305, as oriented in FIG. 7A, in module 310 with formation of a hoop-like leading edge to the tubular composite. The layers of the tubular composite are applied sequentially, preferentially, but not necessarily, from the innermost layer to the outermost layer. In this mode, manufacture of the innermost layer, generally a scaling layer that will contact the contents of the tubular composite, is first initiated. The sealing layer is supported on a cantilevered mandrel 315, thereby allowing movement of the sealing layer, and eventually the entire structure of the tubular composite, in an upward direction in PMP 305 as oriented in FIG. 7A.

As the tubular composite is formed, its leading edge moves upward, as oriented in FIG. 7A, into adjacent modules 320, 325, 330, and 335. The mandrel penetrates each of the adjacent modules, allowing uninterrupted passage of the growing tubular composite between modules. Typically, but not necessarily, each of the modules is tasked with applying a single concentric layer on the nascent tubular composite. PMP 305 (e.g., as described herein in connection with exemplary TC 105), having a total of five modules, can therefore provide five independent layers for the tubular composite. After an initial priming period, the leading edge emerges from uppermost module 335, with the growing tubular composite following behind it. The leading edge of the tubular composite is then held stationary, and the entire PMP 305 is driven downward, as oriented in FIG. 7A, and away from the leading edge, as the tubular composite increases in length. A mechanism for driving PMP 305 is represented by tires 340, any or all of which may be motor driven.

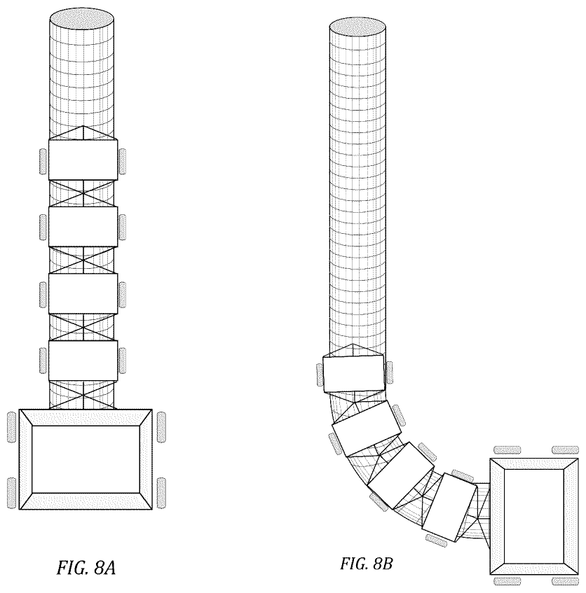

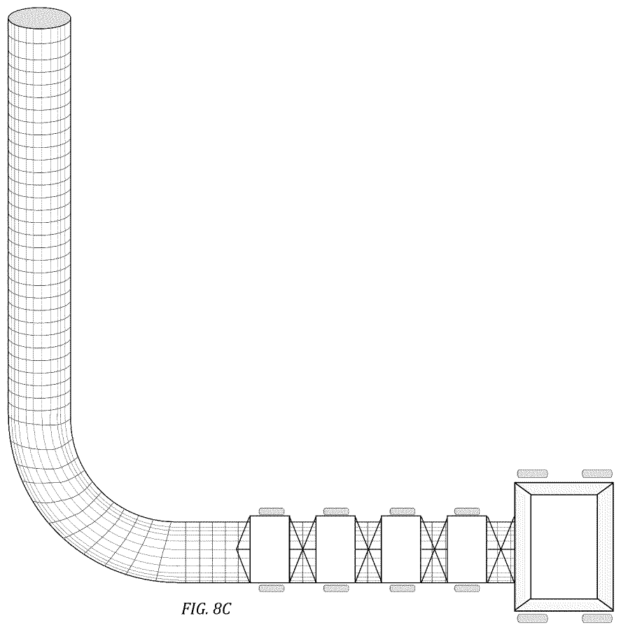

Many variations of a PMP for creation of tubular composites as described herein will be apparent, including a PMP that is housed in a monolithic body, rather than having the partitioned, modular design of PMP 305. A benefit of this modular design is that it allows inclusion of hinges 345, 350, 355, and 360 between adjacent modules. Pivot of the hinges allows reconfiguration of PMP 305 increasingly away from linearity, as shown in FIGS. 7B, 7C, and 7D. Mandrel 315 is also provided as a hinged assembly, and thereby is able to follow the bend of PMP 305. The effect of applying curvature to PMP 305 is that it can induce, through contact forces with the (curved) mandrel, a curvature in the resulting tubular composites. As a result, the curvature of the resulting tubular composite can vary down the tube length. This process is shown in FIGS. 8A-C for manufacture of a tubular composite in the “candlestick” layout. Manufacture of a straight run of tubular composite is depicted in FIG. 8A, in which PMP 305 is held in a linear configuration, directed downward as oriented in FIG. 8A. PMP 305 is then reconfigured to a curved geometry to form the elbow run in FIG. 8B. After reconfiguration back to the linear geometry, as shown in FIG. 8C, the PMP 305, now in a horizontal orientation relative to FIG. 8C, manufactures the transverse run of the “candlestick” tubular composite.

While the methods and manufactures have described in detail and with reference to specific examples thereof. it will be apparent to one skilled in the art that various changes and modifications can be made therein without departing from the spirit and scope thereof.

What is claimed is:

1. A facility for storing liquids or gases, the facility comprising:
a plurality of tubular composites each having a first end and a second end, wherein the first end of each tubular composite is connected to a fitting structured and configured to permit transfer of a liquid or gas into and out of the tubular composite;
a first manifold connected to the fitting of each of the tubular composites; and
a first supply/offtake port connected to the first manifold via a first closable valve.

2. The facility of claim 1, wherein the first manifold includes a plurality of fitting valves, wherein each of fittings is coupled to a respective one of the fitting valves to control a flow of liquid or gas into or out of the tubular composite of the fitting.

3. The facility of claim 1, further comprising a media management center coupled to the first supply/offtake port, wherein the media management center which provides controls for selectively driving transfer of media into and out of the plurality of tubular composites through the fittings and the first manifold.

4. The facility of claim 3, further comprising one or more sensors embedded in or coupled to each of the tubular composites, wherein the media management center includes a health and risk monitoring system structured and configured to collect telemetry data from the sensors to serve as a centralized resource for observing and documenting a health of each of tubular composites based on the telemetry data.

5. The facility of either one of claims 4, wherein each of the sensors is capable of reporting on an event chosen from a leak, seismic activity, and digging.

6. The facility of either one of claims 4, wherein each of the sensors is capable of reporting on a parameter including one or more of static pressure, cyclic pressure, static temperature, cyclic temperature, strain, media flow, and media mass.

7. The facility of claim 3, wherein the media management center is further structured and configured to generate a fluid for storage in one or more of the tubular composites.

8. The facility of claim 7, wherein the fluid is hydrogen.

9. The facility of claim 7, wherein the media management center is structured and configured to generate the fluid through electrolysis.

10. The facility of claim 7, wherein the media management center is structured and configured to generate the fluid through is steam methane reforming.

11. The facility of claim 1, wherein each of the tubular composites has a linear geometry.

12. The facility of claim 11, wherein the first ends of each of the tubular composites are coplanar.

13. The facility of claim 1, wherein each of the tubular composites is oriented horizontally.

14. The facility of claim 1, wherein each of the tubular composites is at least partially embedded in the ground.

15. The facility of claim 14, wherein each of the tubular composites is enclosed within a sheath comprising an attenuation gel.

16. The facility of claim 15, wherein the sheath provides resistance to oxygen.

17. The facility of claim 15, wherein the sheath provides resistance to seismic activity.

18. The facility of claim 15, wherein each of the tubular composites is contained within a casing external to and concentric with the sheath.

19. The facility of claim 1, wherein each of the tubular composites is oriented vertically.

20. The facility of claim 19, wherein the plurality of tubular composites are arranged into a plurality of vertical planes.

21. The facility of claim 1, wherein the first manifold is partitioned into one or more sub-manifolds by the inclusion of one or more closable valves capable of isolating a plurality of tubular composites from the remaining set of tubular composites connected to the first manifold.

22. The facility of claim 1, further comprising:
a second manifold connected to the fitting of each of the tubular composites; and
a second supply/offtake port connected to the second manifold via a second closable valve;
wherein the fitting of each tubular composite is connected to the first manifold and the second manifold via a tee valve.

23. The facility of claim 22, further comprising a first vent mast connected to the first closable valve and a second vent mast connected to the first closable valve.

24. The facility of claim 1, further comprising a vent mast connected to the first closable valve.

25. The facility of claim 1, wherein at least one of the tubular composites can be held at a pressure independent of the remaining tubular composites.

26. The facility of claim 25, wherein each of the plurality of tubular composites can be held at a pressure independent of the remaining tubular composites.

27. The facility of claim 1, wherein each of the tubular composites comprises a sealing layer comprising an inner-most layer of the tubular composite.

28. The facility of claim 27, wherein the sealing layer comprises a plastic material.

29. The facility of claim 28, wherein the plastic material is a fluoropolymer, biobased plastic, or reinforced or non-reinforced 3D printing stock material.

30. The facility of claim 1, wherein each of the tubular composites comprises an axial reinforcement layer.

31. The facility of claim 30, wherein the axial reinforcement layer comprises twisted rope threads.

32. The facility of claim 31, wherein the axial reinforcement layer is fabricated from a material chosen from graphene hybrid micro-rope, unidirectional carbon fiber, glass fiber micro-rope, Kevlar micro-rope, aramid fiber micro-rope, and polyethylene fiber micro-rope.

33. The facility of claim 1, wherein each of the tubular composites comprises one or more hoop reinforcement layers.

34. The facility of claim 33, wherein each of the plurality of tubular composites comprises two hoop reinforcement layers.

35. The facility of claim 24, wherein the two hoop reinforcement layers have opposite helicity.

36. The facility of claim 33, wherein at least one of the one or more hoop reinforcement layers comprises twisted rope threads made of polyethylene infused carbon fiber.

37. The facility of claim 1, wherein each of the plurality of tubular composites comprises a protective layer made of a material chosen from nylon, tear-resistant PTFE, infused fiberglass fabric, infused carbon fiber, infused Kevlar fabric and polyethylene fabric.

38. The facility of claim 1, wherein each of the tubular composites comprises one or more sensor array layers structured and configured to detect a change in one or more properties chosen from temperature, pressure, flow, tension, fatigue, wall thickness, and corrosion.

39. The facility of claim 1, wherein the plurality of tubular composites comprises a plurality of nested U-shaped tubular composites.

40. A method for the fabrication of a reinforcing layer of a tubular composite, the method comprising the steps of:
providing a plurality of polyethylene infused carbon fibers;
twisting each of the carbon fibers under torsional load to form a plurality twisted rope-like threads;
bonding the plurality twisted rope-like threads to form a number of bonded threads; and
forming the reinforcing layer using the number of bonded threads.

41. The method of claim 40, further comprising the step of:
bonding the plurality twisted rope-like threads with a material chosen from polyethylene and EVA, thereby forming a flat tape.

42. The method of claim 41, wherein the flat tape contains between 1 and 200, inclusive, of the twisted rope-like threads.

43. The method of claim 40, wherein the reinforcing layer is structured to surround a sealing layer of the tubular composite as an axial reinforcement layer to provide longitudinal strength for the tubular composite.

44. The method of claim 40, wherein the reinforcing layer is structured to surround a sealing layer of the tubular composite as a hoop axial reinforcement layer to provide mechanical strength against circumferential (hoop) stress for the tubular composite.

45. A tubular composite, comprising:
a sealing layer;
a reinforcing layer provided about the sealing layer, the reinforcing layer comprising bonded twisted rope-like threads, each twisted rope-like thread comprising a plurality of torsionally twisted polyethylene infused carbon fibers.

46. The tubular composite of claim 45, wherein the reinforcing layer is an axial reinforcement layer to provide longitudinal strength for the tubular composite.

47. The tubular composite of claim 45, wherein the reinforcing layer is a hoop axial reinforcement layer to provide mechanical strength against circumferential (hoop) stress for the tubular composite.

48. The facility of claim 30, wherein the axial reinforcement layer comprises bonded twisted rope-like threads, each twisted rope-like thread comprising a plurality of torsionally twisted polyethylene infused carbon fibers.

49. The facility of claim 33, wherein at least one of the one or more hoop reinforcement layers comprises bonded twisted rope-like threads, each twisted rope-like thread comprising a plurality of torsionally twisted polyethylene infused carbon fibers.

50. A method of constructing a facility for storing liquids or gases, comprising:
fabricating a plurality of tubular composites using a portable manufacturing platform, wherein each tubular composite is progressively fabricated from constituent materials beginning at a first end of the portable manufacturing platform such that the tubular composite moves along a length of the portable manufacturing platform away from the first end of the portable manufacturing platform as is it fabricated; and
for each of the tubular composites, moving the portable manufacturing platform during at least a part of the fabricating, wherein the tubular composite has a leading end and wherein the moving companies moving the portable manufacturing platform away from the leading end.

51. The method of claim 50, wherein the leading end of each tubular composite is provided with a fitting structured and configured to permit transfer of a liquid or gas into and out of the tubular composite, the method further comprising:
providing a first manifold connected to the fitting of each of the tubular composites; and
providing a first supply/offtake port connected to the first manifold via a first closable valve.

52. The method of claim 50, wherein the portable manufacturing platform includes a cantilevered cylindrical mandrel and wherein each of the tubular composites is formed on an exterior of the cantilevered cylindrical mandrel while the tubular composite is drawn down a length of the mandrel.

53. The method of claim 50, wherein each of the plurality of tubular composites extends in a linear fashion.

54. The method of claim 50, wherein each of the plurality of tubular composites includes a portion that extends in a non-linear fashion.

55. The method of claim 50, further comprising embedding each of the tubular composites at least partially below ground.

56. The method of claim 50, further comprising embedding each of the tubular composites fully below ground.

57. The method of either one of claim 56, further comprising the steps of:
for each of the plurality of tubular composites:
excavating a vertical borehole in the ground at the intended site for the tubular composite;
positioning a cylindrical casing within the borehole;
positioning the tubular composite in the cylindrical casing positioned within the borehole, thereby locating the tubular composite at least partially below ground and forming an empty interstitial space underneath, surrounding, and/or above the tubular composite;
filling the empty interstitial space with a fluid precursor for an attenuation gel; and
curing the fluid precursor in the interstitial space, thereby providing the attenuation gel.

58. The method of claim 50, wherein a radius of curvature for each tubular composite is varied during fabrication.
